(19) United States
(12) Patent Application Publication
(10) Pub. No.: US 2023/0416574 A1
(43) Pub. Date: Dec. 28, 2023

(54) ADHESIVE COMPOSITIONS AND ARTICLES

(71) Applicant: 3M INNOVATIVE PROPERTIES COMPANY, St. Paul, MN (US)

(72) Inventors: Michael J. Maher, St. Paul, MN (US); Deborah K. Schneiderman, St. Paul, MN (US); Adam O. Moughton, Minneapolis, MN (US)

(21) Appl. No.: 18/251,320

(22) PCT Filed: Oct. 15, 2021
(86) PCT No.: PCT/IB2021/059519

§ 371 Date: May 1, 2023

Related U.S. Application Data
(60) Provisional application No. 63/199,127, filed on Dec. 8, 2020.

(51) Int. Cl. C09J 7/38; C09J 133/10

(52) U.S. Cl. CPC C09J 7/385; C09J 133/10; C09J 2301/312; C09J 2301/408; C09J 2301/302; C09J 2203/326; C09J 2301/50

(57) ABSTRACT

An adhesive composition, a method of making the adhesive composition, and an article that contains the adhesive composition are provided. The adhesive composition contains a polymeric material that includes a monomeric unit derived from a polyether (meth)acrylamide macromer having a polyether group comprising at least 50 mole percent propylene oxide based on total moles of alkylene oxide in the polyether group. The article includes a layer of the adhesive composition positioned next to a substrate. The articles can be, for example, an adhesive tape or can be part of another article such as, for example, an electronic device that is impact resistant and/or flexible.

### BACKGROUND

In electronic devices, particularly mobile electronic devices (e.g., handheld or wearable electronic devices), pressure sensitive adhesives (PSAs) are typically used to bond the cover glass (or lens) to the underlying display module of an electronic device, bond the touch sensor to the cover glass and the display, or bond the lower components of the display to the housing. The pressure-sensitive adhesives used in mobile electronic devices are usually optically clear adhesives (OCAs). For these applications (commonly referred to as electronics bonding or e-bonding), PSAs and OCAS should have sufficiently high adhesive strength to properly maintain good adhesion to those components, not only when the mobile electronic devices are operating: under normal conditions, but also when they are deformed by external forces (e.g., bending, folding, flexing) or subjected to traumatic forces (e.g., dropping of the mobile electronic device onto a hard surface). Regarding deformation, the components of the electronic devices may be deformed when users sit in chairs while the electronic devices are in their pockets or press down on the electronic device with their hips. Under such conditions, the pressure sensitive adhesives should have a strength of adhesion that can maintain the adhesion to, for example, the cover glass (sometimes referred to as anti-lifting properties). Regarding traumatic forces, the pressure sensitive adhesives should have a drop/impact resistance that can maintain adhesion of the components even when large instantaneous impacts are applied to the portable electronic devices when dropped.

Adhesives that can dissipate energy and resist delamination forces associated with high strain events (e.g., flexing and folding) and high strain rate events, such as that experienced during a device drop, have gained increasing significance for the electronic device industry. The ability to produce pressure sensitive adhesives that resist de-bonding (via interfacial or cohesive failure modes) during these high impact and dynamic deformations has become a highly desired property, inclusive of traditional performance metrics such as good peel strength, shear strength, tensile adhesion, and creep resistance, amongst others, and thus has become a commercially attractive performance criterion for continued product differentiation within this competitive and fast paced market space.

Given the electronics industry's trend towards device simplification (i.e., combining layers and/or layer functions) and reducing bonding area and overall device thickness, (and moreover demanding enhanced flexibility), there exists a growing need for adhesive compositions that have good impact resistance, compliance, and recovery. Adhesives having this balance of dichotomous properties are needed.

### SUMMARY

An adhesive composition, a method of making the adhesive composition, and an article that contains the adhesive composition are provided. The adhesive composition contains a polymeric material that includes a monomeric unit derived from a polyether (meth)acrylamide macromer having a polyether group comprising at least 50 mole percent propylene oxide based on total moles of alkylene oxide in the polyether group. The article includes a layer of the adhesive composition positioned next to a substrate. The articles can be, for example, an adhesive tape or can be part of another article such as, for example, an electronic device that is impact resistant and/or flexible.

In a first aspect, an adhesive composition is provided that comprises a polymeric material derived from a polymerizable composition that comprises a) a polyether (meth)acrylamide macromer having a polyether group comprising at least 50 mole percent propylene oxide based on total moles of alkylene oxide in the polyether group, b) an alkyl (meth)acrylate, and c) crosslinking agent. The polymerizable composition optionally but usually further includes a polar monomer.

In many embodiments of the adhesive composition of the first aspect, the polymeric material comprises a first polymer and a second polymer. The first polymer is derived from a first polymerizable composition comprising a) an alkyl (meth)acrylate and b) an optional polar monomer. The second polymer is derived from a second polymerizable composition comprising a) a polyether (meth)acrylamide macromer having a polyether group comprising at least 50 mole percent propylene oxide based on total moles of alkylene oxide in the polyether group, b) an alkyl (meth)acrylate, c) an optional polar monomer, and d) a crosslinking agent. In many embodiments, the first polymer, the second polymer, or both contain monomeric units derived from a polar monomer.

In a second aspect, a method of making an adhesive composition is provided. The method includes providing a first polymerizable composition that comprises (1) an alkyl (meth)acrylate and (2) an optional polar monomer. The method further includes forming a syrup composition by partially polymerizing the first polymerizable composition. The syrup composition contains (1) 1 to 20 weight percent solute polymer, which is a first polymer, and (2) 80 to 99 weight percent solvent monomers based on a total weight of the syrup composition, wherein the solvent monomers comprise (i) the alkyl (meth)acrylate and (ii) the optional polar monomer. The solute polymer has a weight average molecular weight of at least 100,000 Daltons. The method yet further includes preparing a second polymerizable composition comprising (1) the syrup composition, (2) a polar monomer if the syrup composition is free of the optional polar monomer or if more polar monomer is desired, (3) a polyether (meth)acrylamide macromer having a polyether group comprising at least 50 mole percent propylene oxide based on total moles of alkylene oxide in the polyether group, and (4) a crosslinking agent. The method still further includes polymerizing the second polymerizable composition to form the adhesive composition comprising (1) the first polymer plus (2) a second polymer. Either the second polymer or both the second polymer and the first polymer are crosslinked.

In a third aspect, an adhesive composition is provided that contains a polymerized product of a second polymerizable composition comprising (a) a syrup composition that is a partially polymerized reaction product of a first polymerizable composition comprising, (b) a polar monomer if the syrup composition is free of the optional polar monomer, (c) a polyether (meth)acrylamide macromer having a polyether group comprising at least 50 mole percent propylene oxide based on total moles of alkylene oxide in the polyether group, and (d) a crosslinking agent. The syrup composition contains (1) 1 to 20 weight percent solute polymer based on a total weight of the syrup, the solute polymer being a first polymer having a weight average molecular weight of at least 100,000 Daltons and (2) 80 to 99 weight percent solvent monomers based on a total weight of the syrup, wherein the solvent monomers comprise (i) the alkyl (meth)acrylate and (ii) an optional polar monomer. The polymerized product of the second polymerizable composition is the adhesive composition comprising the first polymer and a second polymer. Either the second polymer or both the second polymer and the first polymer are crosslinked.

In a fourth aspect, an article is provided that includes a substrate and an adhesive composition positioned adjacent to a substrate. The adhesive composition is described above in the first or third aspect.

The term “and/or” such as in the expression A and/or B means A alone, B alone, or both A and B.

The term “polymer” and “polymeric material” are used interchangeably to refer to homopolymers, copolymers, terpolymers, and the like.

The term “polymerizable component” refers to a compound that can undergo polymerization (i.e., the compound has a polymerizable group). The polymerizable component typically has an ethylenically unsaturated group such as a (meth)acryloyl-containing group or a vinyl group that is the polymerizable group. The polymerizable component can be referred to interchangeably as a “monomer”. The term “macromer” refers to a monomer having a polymeric group such as a polyether group (i.e., macromers are a subset of monomers).

The term “polymerizable composition” refers to the reaction mixture that can be polymerized. It includes the polymerizable components (i.e., monomers including macromers) plus any other material such as a free radical initiator, chain transfer agent, antioxidant, solvent, and the like that may be included in the reaction mixture.

The term “monomeric unit” refers to the reaction product of a polymerizable component (i.e., a monomer (including a macromer)) within the polymeric material. As an example, the monomeric unit of acrylic acid

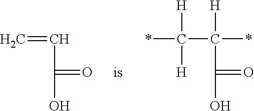

where the asterisks (*) indicate the attachment site to another group such as another monomeric unit in the polymer.

The term “(meth)acryloyl” refers to a group of formula CH₂═CR—(CO)— where R is hydrogen (for an acryloyl group) or methyl (for a methacryloyl group).

The term “(meth)acrylate” refers to a methacrylate and/or acrylate. Likewise, the term (meth)acrylic acid” refers to methacrylic acid and/or acrylic acid and the term “(meth)acrylamide” refers to methacrylamide and/or acrylamide.

The term “polyether (meth)acrlamide macromer” refers to a monomer having a single group of formula CH₂═CR—(CO)—NH— where R is hydrogen or methyl plus a polyether group. The term “polyether” refers to a polymeric group having at least 3 alkylene oxide groups. The alkylene oxide groups are often selected from ethylene oxide (—(C₂H₄O)—), propylene oxide(-(C₃H₆O)—), or a mixture thereof.

The term “vinyl” refers to a polymerizable component that has a group CH₂═CH— but that is not part of a (meth)acryloyl group.

The term “syrup” refers to a composition that contains both unreacted monomers and a polymerized product of monomers. The polymerized product can be referred to as a “solute polymer” and it is dissolved in the monomers. That is, the monomers function as a solvent for the polymerized product and can be referred to as “solvent monomers”. The syrup usually contains little or no other solvent such as a non-reactive organic solvent. The syrup is typically present as a homogeneous mixture with any liquids being miscible with each other.

Herein, the term “pressure-sensitive adhesive” or “PSA” is used in its conventional manner according to the Pressure-Sensitive Tape Council, which states that pressure-sensitive adhesives are known to possess properties including the following: (1) aggressive and permanent tack, (2) adherence with no more than finger pressure, (3) sufficient ability to hold onto an adherend, and (4) sufficient cohesive strength to be removed cleanly from the adherend. Materials that have been found to function well as PSAs include polymers designed and formulated to exhibit the requisite viscoelastic properties resulting in a desired balance of tack, peel adhesion, and shear holding power. PSAs are characterized by being normally tacky at room temperature (e.g., 20° C.). Central to all PSAs is a desired balance of adhesion and cohesion that is often achieved by optimizing the physical properties of the elastomer, such as glass transition temperature and modulus. For example, if the glass transition temperature (T_{g}) or modulus of the elastomer is too high and above the Dahlquist criterion for tack (storage modulus of 3×10⁶ dynes/cm² at room temperature and oscillation frequency of 1 Hz), the material will not be tacky and is not useful by itself as a PSA material.

Herein, the term “glass transition temperature”, which can be written interchangeably as “T_{g}”, of a monomer (including the macromer) refers to the glass transition temperature of the homopolymer formed from the monomer, which can be a macromer. The glass transition temperature for a polymeric material is typically measured by Dynamic Mechanical Analysis (DMA) as the maximum in tan delta (δ).

As used herein, “flexible” refers to a substrate and/or article that can undergo roll up action with a bend radius of 200 mm or less, 100 mm or less, 50 mm or less, 20 mm or less, 10 mm or less, 5 mm or less, 4 mm or less, 3 mm or less, 2 mm or less, or 1 mm or less, without failure or visible defects, such as delamination, cracking, crazing, or haze.

As used herein, “foldable” refers to a substrate and/or article that can undergo repeated flexing or folding, such as up to 1,000 folds, up to 10,000 folds, up to 25,000 folds, up to 50,000 folds, up to 25,000 folds, up to 100,000 folds, or even up to 200,000 folds, without failure or visible defects such as delamination, cracking, crazing, or haze. In this context, a fold is formed in a substrate or article that is relatively flat when it is bent over (i.e., folded) on itself so that one part of it covers another part. The bend radius for folding is often 200 mm or less, 100 mm or less, 50 mm or less, 20 mm or less, 10 mm or less, 5 mm or less, 4 mm or less, 3 mm or less, 2 mm or less, or 1 mm or less.

Herein, the term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of” Thus, the phrase “consisting of” indicates that the listed elements are required or mandatory, and that no other elements may be present. By “consisting essentially of” is meant including any elements listed after the phrase and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether they materially affect the activity or action of the listed elements. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof).

The words “preferred” and “preferably” refer to embodiments of the disclosure that may afford certain benefits, under certain circumstances. However, other claims may also be preferred, under the same or other circumstances. Furthermore, the recitation of one or more preferred claims does not imply that other claims are not useful and is not intended to exclude other claims from the scope of the disclosure.

In this application, terms such as “a,” “an,” and “the” are not intended to refer to only a singular entity but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all the listed elements or a combination of any two or more of the listed elements.

Also, herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also, herein, the recitations of numerical ranges by endpoints include all numbers subsumed within that range as well as the endpoints (e.g., 1 to 5 includes 1, 1.5, 2, 2.75, 3, 3.80, 4, etc.).

As used herein, the term “room temperature” refers to a temperature of 20° C. to 25° C. or 22° C. to 25° C.

The term “in the range” or “within a range” (and similar statements) includes the endpoints of the stated range.

When a group is present more than once in a formula described herein, each group is “independently” selected, whether specifically stated or not. For example, when more than one R group is present in a formula, each R group is independently selected.

Reference throughout this specification to “one embodiment,” “an embodiment,” “certain embodiments,” or “some embodiments,” etc., means that a specific feature, configuration, composition, or characteristic described in connection with the embodiment is included in at least one embodiment of the invention. Thus, the appearances of such phrases in various places throughout this specification are not necessarily referring to the same embodiment of the invention. Furthermore, the specific features, configurations, compositions, or characteristics may be combined in any suitable manner in one or more embodiments.

The above summary of the present disclosure is not intended to describe each disclosed embodiment or every implementation of the present invention. The description that follows more particularly exemplifies illustrative embodiments. In several places throughout the application, guidance is provided through lists of examples. These examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### DETAILED DESCRIPTION

The present disclosure provides an adhesive composition that contains a polymeric material having monomeric units derived from a polyether (meth)acrylamide macromer. Additionally, articles are provided that contains the adhesive composition positioned adjacent to a substrate. The adhesive composition is typically a pressure-sensitive adhesive. The articles can be, for example, an adhesive tape or can be part of another article that is flexible and foldable such as, for example, an electronic device that is flexible and/or foldable.

Overall, the adhesive composition contains polymeric material derived from a polymerizable composition containing polymerizable components that include an alkyl (meth)acrylate, a polyether (meth)acrylamide macromer, and a crosslinking agent. In many embodiments, the polymerizable composition further includes a polar monomer. The adhesive composition often contains at least two polymers (a first polymer and a second polymer) having different monomeric units and different molecular weights. The first polymer is typically derived from a first polymerizable composition that contains an alkyl (meth)acrylate and an optional polar monomer while the second polymer is derived from a second polymerizable composition that includes a polyether (meth)acrylamide, an alkyl (meth)acrylate, an optional polar monomer, and the crosslinking agent. The second polymer is often prepared in the presence of the first polymer. Typically, at least the second polymer is crosslinked. In some embodiments, depending on the selected crosslinking agent, both the first polymer and the second polymer are crosslinked.

The adhesive composition can be used in the preparation of various articles. The adhesive composition desirably has good peel adhesive strength and remains adhered to a substrate even when the article is flexed, folded, impacted, or exposed to adverse environmental conditions. In some embodiments, the adhesive composition is used in an electronic device including those that are flexible and/or that can withstand an impact such as dropping.

In some embodiments, the process of making the adhesive composition includes preparing the first polymer by partially polymerizing a first polymerizable composition to form a syrup composition. The syrup composition contains a solute polymer, which is the first polymer, dissolved in solvent monomers. The solvent monomers are the unreacted polymerizable components of the first polymerizable composition that includes (a) an alkyl (meth)acrylate and (b) an optional polar monomer. After formation of the first polymer, the following monomers are added to the syrup composition to form a second polymerizable composition: a polyether (meth)acrylamide macromer, a polar monomer if the syrup composition is free of the optional polar monomer (or if additional polar monomer is desired), and a crosslinking agent. That is, the second polymerizable composition contains the first polymer, an alkyl (meth)acrylate, a polar monomer, a polyether (meth)acrylamide macromer, and a crosslinking agent. When polymerization is initiated, a second polymer is formed in the presence of the first polymer. During the second polymerization reaction, the first polymer typically does not undergo further polymerization except perhaps crosslinking depending on the selection of the crosslinking agent. The product is an adhesive composition that contains the first polymer and the second polymer. Either the second polymer or both the second polymer and the first polymer are crosslinked.

The use of polyether (meth)acrylamide macromers, particularly those having a polyether group comprising at least 50 mole percent propylene oxide based on total moles of alkylene oxide in the polyether group, are advantageous over polyether (meth)acrylates in some adhesive applications. The polyether (meth)acrylamides tend to be more resistant to hydrolysis when exposed to high temperature and high humidity conditions (e.g., 60 to 75 degrees Celsius and at least 90 percent relative humidity). Thus, adhesive compositions derived from the polyether (meth)acrylamides rather than polyether (meth)acrylates can have enhanced adhesion properties (e.g., peel strength) at elevated temperatures and/or under high humidity conditions.

Surprisingly, polyether (meth)acrylamides with polyether groups comprising at least 50 mole percent propylene oxide groups tend to adhere more strongly than those with a lower content of propylene oxide. At least in part, this may be due to the lower hydrophobicity of poly(propylene oxide) groups compared to poly(ethylene oxide) groups. Thus, the polyether (meth)acrylamide macromers is selected from (i) (meth)acrylamide macromers having a poly(propylene oxide) group, (ii) (meth)acrylamide macromers having a poly(ethylene oxide-co-propylene oxide) group that contains at least 50 mole propylene oxide based on a total moles of alkylene oxide in the polyether group, or (iii) a mixture of different polyether (meth)acrylamide monomers wherein at least 50 mole percent of the alkylene oxide in all the polyether groups is propylene oxide.

The adhesive compositions that are provided have a combination of good impact resistance and good adhesion to high surface energy surfaces such as stainless steel at room temperature as well as after aging at elevated temperatures (e.g., 60 to 75 degrees Celsius) and under high humidity conditions (e.g., 90 percent relative humidity).

### First Polymerizable Composition

The first polymer is formed from a first polymerizable composition that includes an alkyl (meth)acrylate and an optional polar monomer. Other optional monomers can be included in the first polymerizable composition, but it typically does not contain a polyether (meth)acrylamide macromer. The first polymerizable composition is usually only partially polymerized. Thus, the product of the first polymerizable composition is a syrup composition that contains (a) a syrup polymer that is a first polymer and (b) unreacted solute monomers.

Any suitable alkyl (meth)acrylate or mixture of alkyl (meth)acrylates can be used in the first polymerizable composition. The choice of the alkyl (meth)acrylate can influence the glass transition temperature of the final adhesive composition. Some alkyl (meth)acrylate monomers are classified as low T_{g} monomers based on the glass transition temperature of their corresponding homopolymers. The low T_{g} monomers, as measured from the corresponding homopolymers, often have a T_{g} no greater than 20 degrees Celsius, no greater than 10 degrees Celsius, no greater than 0 degrees Celsius, or no greater than −10 degrees Celsius. Other alkyl (meth)acrylates are classified as high T_{g} monomers based on the glass transition temperature of the corresponding homopolymers. The high T_{g} monomers, as measured from the corresponding homopolymers, often have a T_{g} greater than 30° C., greater than 40° C., or greater than 50° C. The glass transition temperature if often measured using Dynamic Mechanical Analysis (DMA).

Suitable low T_{g} alkyl (meth)acrylate monomers include, but are not limited to, non-tertiary alkyl acrylates but can be an alkyl (meth)acrylates having a linear alkyl group with at least 4 carbon atoms. Specific examples of alkyl (meth)acrylates include, but are not limited to, n-butyl acrylate, n-butyl methacrylate, isobutyl acrylate, sec-butyl acrylate, n-pentyl acrylate, 2-methylbutyl acrylate, n-hexyl acrylate, cyclohexyl acrylate, 4-methyl-2-pentyl acrylate, 2-methylhexyl acrylate, 2-ethylhexyl acrylate, n-octyl acrylate, 2-octyl acrylate, isooctyl acrylate, isononyl acrylate, isoamyl acrylate, n-decyl acrylate, isodecyl acrylate, n-decyl methacrylate, lauryl acrylate, isotridecyl acrylate, n-octadecyl acrylate, isostearyl acrylate, n-dodecyl methacrylate, and combinations thereof. The alkyl (meth)acrylate monomers are typically selected to include at least one low T_{g} monomer such as those that have a T_{g} no greater than −10 degrees Celsius when measured as a homopolymer. Such alkyl monomers include, but are not limited to, 2-ethylhexyl acrylate, isooctyl acrylate, N-butyl acrylate, 2-methylbutyl acrylate, iso-octyl acrylate, 2-octyl acrylate, and combinations thereof.

Some suitable high T_{g} alkyl (meth)acrylate monomers include, for example, methyl methacrylate, ethyl methacrylate, n-propyl methacrylate, isopropyl methacrylate, n-butyl methacrylate, isobutyl methacrylate, sec-butyl methacrylate, tert-butyl (meth)acrylate, cyclohexyl methacrylate, isobornyl (meth)acrylate, stearyl (meth)acrylate, and 3,3,5 trimethylcyclohexyl (meth)acrylate.

The total amount of the alkyl (meth)acrylate can be any amount up to 100 weight percent or up to 99 weight percent based on the total weight of monomers within the first polymerizable composition. The amount can be, for example, up to 98 weight percent, up to 97 weight percent, up to 95 weight percent, up to 92 weight percent, up to 90 weight percent, up to 85 weight percent, or up to 80 weight percent. The lower amount is often at least 50 weight percent but can be lower if optional monomers are included in the first polymerizable composition. The amount is often least 55 weight percent, at least 60 weight percent, at least 65 weight percent, at least 70 weight percent, at least 75 weight percent, at least 80 weight percent, at least 85 weight percent, or at least weight percent.

In addition to the alkyl (meth)acrylate, the first polymerizable composition optionally (but usually) contains a polar monomer. The polar monomer contains an ethylenically unsaturated group plus a polar group. The ethylenically unsaturated group is either a vinyl or (meth)acryloyl group. Suitable polar groups can be an acidic group, a hydroxyl group, an ether (or polyether) group, or a nitrogen-containing group. The nitrogen-containing group is typically a primary amido group, secondary amido group, tertiary amido group, or amino group. A polar monomer with an acidic group can be referred to as an “acidic polar monomer” while those with a hydroxyl group, ether group, or nitrogen-containing group can be referred to as a “non-acidic polar monomer”.

Although acidic polar monomers can have any suitable acidic group such as a sulfonic acid group, phosphonic acid group, or carboxylic acid group, the acidic group is often a carboxylic acid group. Exemplary polar monomers with a carboxylic acid group include those selected from (meth)acrylic acid, β-carboxyethyl (meth)acrylate, 2-(meth)acryloyloxyethyl phthalic acid, 2-(meth)acryloyloxy succinic acid, and combinations thereof. In many embodiments, the polar monomer with an acidic group is (meth)acrylic acid and is often acrylic acid. Depending on the pH, the acidic polar monomers can be in the form of a salt.

Exemplary polar monomers with a hydroxyl group include, but are not limited to, hydroxyalkyl (meth)acrylates (e.g., 2-hydroxyethyl (meth)acrylate, 2-hydroxypropyl (meth)acrylate, 3-hydroxypropyl (meth)acrylate, and 4-hydroxybutyl (meth)acrylate), hydroxyalkyl (meth)acrylamides (e.g., 2-hydroxyethyl (meth)acrylamide and 3-hydroxypropyl (meth)acrylamide), ethoxylated hydroxyethyl (meth)acrylate, aryloxy substituted hydroxyalkyl (meth)acrylates (e.g., 2-hydroxy-2-phenoxypropyl (meth)acrylate), and hydroxy-propyl-carbamate acrylate.

Exemplary ether-containing polar monomers include those selected from 2-ethoxyethoxyethyl (meth)acrylate, 2-methoxyethoxyethyl (meth)acrylate, di(ethylene glycol)-2-ethylhexyl-ether acrylate, ethylene glycol-methyl ether acrylate, and combinations thereof. Suitable ether-containing (meth)acrylate monomers usually have a number average molecular weight less than 300 Daltons, less than 275 Daltons, or less than 250 Daltons.

Exemplary polar monomers with a primary amido group include (meth)acrylamide. Exemplary polar monomers with secondary amido groups include, but are not limited to, N-alkyl (meth)acrylamides and N-alkoxyalkyl (meth)acrylamides such as N-methyl (meth)acrylamide, N-ethyl (meth)acrylamide, N-isopropyl (meth)acrylamide, and N-octyl (meth)acrylamide, N-(3-methoxypropyl)acrylamide, and N-(isobutoxymethyl)acrylamide. Exemplary polar monomers with a tertiary amido group include, but are not limited to, N-vinyl carbazole, N-vinyl caprolactam, N-vinyl-2-pyrrolidone, N-vinyl azlactone, 4-(meth)acryloylmorpholine, N-vinylimidazole, ureido (meth)acrylate, and N,N-dialkyl (meth)acrylamides such as N,N-dimethyl (meth)acrylamide, N,N-diethyl (meth)acrylamide, N,N-dipropyl (meth)acrylamide, and N,N-dibutyl (meth)acrylamide.

Polar monomers with an amino group include various N,N-dialkylaminoalkyl (meth)acrylates and N,N-dialkylaminoalkyl (meth)acrylamides. Examples include, but are not limited to, N,N-dimethyl aminoethyl (meth)acrylate, N,N-dimethylaminoethyl (meth)acrylamide, N,N-dimethylaminopropyl (meth)acrylate, N,N-dimethylaminopropyl (meth)acrylamide, N,N-diethylaminoethyl (meth)acrylate, N,N-diethylaminoethyl (meth)acrylamide, N,N-diethylaminopropyl (meth)acrylate, and N,N-diethylaminopropyl (meth)acrylamide.

The first polymerizable composition can include 0 to 50 weight percent polar monomer. This amount is often no greater than 50 weight percent, no greater than 45 weight percent, no greater than 40 weight percent, no greater than 35 weight percent, no greater than 30 weight percent, no greater than 25 weight percent, no greater than 20 weight percent, no greater than 15 weight percent, no greater than 10 weight percent, or no greater than 5 weight percent based on a total weight of polymerizable components. If present, the amount of the polar monomer or mixtures thereof is often at least 0.1 weight percent, at least 0.5 weight percent, at least 1 weight percent, at least 2 weight percent, at least 5 weight percent, at least 10 weight percent, at least 15 weight percent, or at least 20 weight percent based on a total weight of monomers in the first polymerizable composition.

The polar monomer can be an acidic polar monomer, a non-acidic polar monomer, or a combination thereof. If the first polymerizable composition includes acidic polar monomer, the amount of the acidic polar monomer is usually present in an amount no great than 30 weight percent based on a total weight of monomers in the first polymerizable composition. Typically, if more than 30 weight percent of the acidic polar monomer is used, the resultant adhesive composition may be too stiff. The amount is often no greater than 25 weight percent, no greater than 20 weight percent, no greater than 15 weight percent, 12 weight percent, no greater than 10 weight percent, no greater than 8 weight percent, no greater than 6 weight percent, no greater than weight percent, no greater than 4 weight percent, no greater than 3 weight percent, or no greater than 2 weight percent and at least 0.5 weight percent, at least 1 weight percent, at least 2 weight percent, at least 3 weight percent, or at least 5 weight percent based on the total weight of monomers in the first polymerizable composition. The amount of any non-acidic polar monomers combined with the acidic polar monomer can be any amount such that the sum of all the polar monomers is no greater than 50 weight percent, no greater than 45 weight percent, no greater than 40 weight percent, no greater than 35 weight percent, no greater than 30 weight percent, no greater than 25 weight percent, no greater than 20 weight percent, no greater than 15 weight percent, no greater than 10 weight percent, or no greater than 5 weight percent based on a total weight of monomers in the first polymerizable composition.

In some embodiments, first polymerizable composition often includes both an acidic polar monomer and a nitrogen-containing polar monomer (e.g., a polar monomer with a primary amido group, a secondary amido group, a tertiary amido group, or an amino group). This combination of polar monomers can provide an adhesive composition that has excellent high impact resistance, and/or drop resistance properties, and excellent bond making ability (i.e., good tack, instant bond formation). These performance criteria are often highly desirable for applications within e-bonding and industrial market segments.

The first polymerizable composition often contains 50 to 100 weight percent alkyl (meth)acrylate and 0 to 50 weight percent polar monomer based on a total weight of polymerizable components in the first polymerizable composition. In many embodiments, the first polymerizable composition contains 50 to 99 weight percent alkyl (meth)acrylate and 1 to 50 weight percent polar monomer, 60 to 99 weight percent alkyl (meth)acrylate and 1 to 40 weight percent polar monomer or 70 to 99 weight percent alkyl (meth)acrylate and 1 to 30 weight percent polar monomer. For example, the first polymerizable composition can include 70 to 95 weight percent alkyl (meth)acrylate and 5 to 30 weight percent polar monomer, 80 to 99 weight percent alkyl (meth)acrylate and 1 to 20 weight percent polar monomer, 80 to 95 weight percent alkyl (meth)acylate and 5 to 20 weight percent polar monomer, 85 to 95 weight percent alkyl (meth)acrylate and 1 to 15 weight percent polar monomer, 85 to 95 weight percent alkyl (meth)acylate and 5 to 15 weight percent polar monomer, or 80 to 90 weight percent alkyl (meth)acylate and 10 to 20 weight percent polar monomer. If the polar monomer includes an acidic monomer, the amount of the acidic monomer can be 0.5 to 30 weight percent, 0.5 to 20 weight percent, or 0.5 to 15 weight percent with any remainder polar monomer being a non-acidic polar monomer.

Other optional monomers can be included in the first polymerizable composition. The optional monomers typically do not include a macromer or a crosslinking agent. In many embodiments, the first polymerizable composition is free or substantially free of vinyl acetate and non-polar vinyl monomers. As used herein to describe vinyl acetate and non-polar vinyl monomers, the term “substantially free” means that the first polymerizable composition contain no greater than 1 weight percent, no greater than 0.5 weight percent, no greater than 0.2 weight percent, no greater than 0.1 weight percent, no greater than 0.05 weight percent, or no greater than weight percent of these monomers based on the total weight of monomers.

In addition to the monomers (e.g., an alkyl (meth)acylate and an optional polar monomer), the first polymerizable composition typically includes a free-radical initiator. The initiator can be a thermal initiator or a photoinitiator. Multiple thermal initiators or photoinitiators can be used. The amount of the free radical initiator can influence the molecular weight of the first polymer, with larger amounts of the free radical initiator typically producing lower molecular weight polymers. The amount of the initiator is often in a range of 0.01 to 5 weight percent based on the total weight of polymerizable components in first polymerizable composition. The amount can be at least 0.01 weight percent, at least 0.05 weight percent, at least 0.1 weight percent, at least 0.2 weight percent, at least 0.5 weight percent, or at least 1 weight percent and up to 5 weight percent, up to 4 weight percent, up to 3 weight percent, up to 2 weight percent, up to 1 weight percent, or up to 0.5 weight percent.

Exemplary thermal initiators include various azo compound such as those commercially available under the trade designation VAZO from Chemours Co. (Wilmington, DE, USA) including VAZO 67, which is 2,2′-azobis(2-methylbutane nitrile), VAZO 64, which is 2,2′-azobis(isobutyronitrile), VAZO 52, which is (2,2′-azobis(2,4-dimethylpentanenitrile), and VAZO 88, which is 1,1′-azobis(cyclohexanecarbonitrile); various peroxides such as benzoyl peroxide, cyclohexane peroxide, lauroyl peroxide, di-tert-amyl peroxide, tert-butyl peroxy benzoate, di-cumyl peroxide, and peroxides commercially available from Atofina Chemical, Inc. (Philadelphia, PA, USA) under the trade designation LUPERSOL (e.g., LUPERSOL 101, which is 2,5-bis(tert-butylperoxy)-2,5-dimethylhexane, and LUPERSOL 130, which is 2,5-dimethyl-2,5-di-(tert-butylperoxy)-3-hexyne); various hydroperoxides such as tert-amyl hydroperoxide and tert-butyl hydroperoxide; and mixtures thereof.

In many embodiments, a photoinitiator is used to form the first polymer. Some exemplary photoinitiators are benzoin ethers (e.g., benzoin methyl ether or benzoin isopropyl ether) or substituted benzoin ethers (e.g., anisoin methyl ether). Other exemplary photoinitiators are substituted acetophenones such as 2,2-diethoxyacetophenone or 2,2-dimethoxy-2-phenylacetophenone (commercially available under the trade designation IRGACURE 651 from BASF Corp. (Florham Park, NJ, USA) or under the trade designation ESACURE KB-1 from Sartomer (Exton, PA, USA)). Still other exemplary photoinitiators are substituted alpha-ketols such as 2-methyl-2-hydroxypropiophenone, aromatic sulfonyl chlorides such as 2-naphthalenesulfonyl chloride, and photoactive oximes such as 1-phenyl-1,2-propanedione-2-(O-ethoxycarbonyl)oxime. Other suitable photoinitiators include, for example, 1-hydroxycyclohexyl phenyl ketone (commercially available under the trade designation IRGACURE 184), bis(2,4,6-trimethylbenzoyl)phenyl phosphine oxide (commercially available under the trade designation IRGACURE 819), 1-[4-(2-hydroxyethoxy)phenyl]-2-hydroxy-2-methyl-1-propane-1-one (commercially available under the trade designation IRGACURE 2959), 2-benzyl-2-dimethylamino-1-(4-morpholinophenyl)butanone (commercially available under the trade designation IRGACURE 369), 2-methyl-1-[4-(methylthio)phenyl]-2-morpholinopropan-1-one (commercially available under the trade designation IRGACURE 907), and 2-hydroxy-2-methyl-1-phenyl propan-1-one (commercially available under the trade designation DAROCUR 1173 from Ciba Specialty Chemicals Corp. (Tarrytown, NY, USA)).

Chain-transfer agents optionally can be included in the first polymerizable composition to control the molecular weight of the first polymer. Suitable chain-transfer agents include, but are not limited to, those selected from the group of carbon tetrabromide, hexabromoethane, bromotrichloromeihane, 2-mercaptoethanol, tert-dodecylmercaptan, isooctylthioglycoate, 3-mercapto-1,2-propanediol, cumene, pentaerythritol tetrakis(3-mercapto butyrate) (available wider the trade name KARENZ MT PE1 from Showa Denko), ethylene glycol bisthioglycolate, and mixtures thereof. Depending on the reactivity of the chain-transfer agent selected, the amount of chain transfer agent is often in a range of 0 to 5 weight percent based on the total weight of monomers in the first polymerizable composition. In some embodiments, the amount of the chain transfer agent is at least 0.05 weight percent, at least 0.1 weight percent, at least 0.2 weight percent, at least 0.3 weight percent, or at least 0.5 weight percent and can be up to 5 weight percent, up to 4.5 weight percent, up to 4 weight percent, up to 3.5 weight percent, up to 3 weight percent, up to 2.5 weight percent, up to 2 weight percent, up to 1.5 weight percent, or up to 1 weight percent. The weight percent values are based on the total weight of the polymerizable components in the first polymerizable composition to form the first polymer.

Polymerization of the first polymerizable composition to form the first polymer can occur in the presence or absence of an optional non-reactive organic solvent. If a non-reactive organic solvent is included in the first polymerizable composition, the amount is often selected to provide the desired viscosity. Examples of suitable non-reactive organic solvents include, but are not limited to, methanol, tetrahydrofuran, ethanol, isopropanol, pentane, hexane, heptane, acetone, methyl ethyl ketone, methyl acetate, ethyl acetate, toluene, xylene, and ethylene glycol alkyl ether. Those organic solvents can be used alone or as mixtures thereof. If used, the amount of the non-reactive organic solvent is often no greater than 10 weight percent, no greater than 5 weight percent, no greater than 4 weight percent, no greater than 3 weight percent, no greater than 2 weight percent, or no greater than 1 weight percent based on a total weight of the first polymerizable composition. In some embodiments, no non-reactive organic solvent is purposely added but may be a component (e.g., contaminant or diluent) of another constituent of the first polymerizable composition. In many embodiments, the first polymerizable composition is free or substantially free of non-reactive organic solvents. As used herein with reference to the non-reactive organic solvent, “substantially free” means that the first polymerizable composition contains less than 1 weight percent, less than 0.5 weight percent, less than 0.1 weight percent, less than 0.05 weight percent, or less than 0.01 weight percent non-reactive organic solvent.

The first polymerizable composition is typically partially polymerized to form a syrup composition that contains a solute polymer dissolved in solute monomers. The polymerization process typically occurs by exposure of the first polymerizable composition to actinic radiation, which is often ultraviolet radiation, or to heat (e.g., 40 to 100 degrees Celsius). The solute polymer is the first polymer and the solute monomers are the unreacted monomers. The polymerization time is typically selected so that no greater than 20 weight percent of the monomers in the first polymerizable composition are polymerized. That is, the syrup composition usually contains 1 to 20 weight percent solute polymer (i.e., the first polymer) and 80 to 99 weight percent solvent monomers based on a total weight of the syrup composition. The amount of the solute polymer can be at least 1 weight percent, at least 2 weight percent, at least 3 weight percent, at least 5 weight percent, or at least 10 weight percent and up to 20 weight percent, up to 15 weight percent, up to 10 weight percent, or up to 5 weight percent based on the total weight of monomers in the first polymerizable composition. The remainder of the syrup composition is typically predominately the solvent monomers (e.g., there can be small amounts of other components added to the first polymerizable composition such as the initiator and/or chain transfer agent and/or non-reactive organic solvent).

In some examples, the syrup composition contains 1 to 15 weight percent first polymer and 85 to 99 weight percent solvent monomers, 1 to 10 weight percent first polymer and 90 to 99 weight percent solvent monomers, 5 to 20 weight percent first polymer and 80 to 95 weight percent solvent monomers, or 5 to 15 weight percent first polymer and 85 to 95 weight percent solvent monomers. The solvent monomers include both the alkyl (meth)acrylate and the optional polar monomer. The amounts are based on the total weight of the syrup composition.

In some more specific examples, the syrup composition contains 1 to 20 weight percent first polymer, 0 to 50 weight percent polar monomers, and 50 to 99 weight percent alkyl (meth)acrylate monomers or 1 to 20 weight percent first polymer, 1 to 50 weight percent polar monomers, and 50 to 98 weight percent alkyl (meth)acrylate monomers. For example, the syrup composition can contain 1 to 20 weight percent first polymer, 0 to 40 weight percent polar monomers, and 50 to 99 weight percent alkyl (meth)acrylate monomers or 1 to 20 weight percent first polymer, 1 to 40 weight percent polar monomers, and 50 to 98 weight percent alkyl(meth)acrylate monomers. In some examples, the syrup compositions contain 1 to 20 weight percent first polymer, 1 to 30 weight percent polar monomers, and 50 to 98 weight percent alkyl (meth)acrylate monomers or 1 to 20 weight percent first polymer, 1 to 15 weight percent polar monomers, and 65 to 98 weight percent alkyl (meth)acrylate monomers. In other examples, the syrup composition contains 5 to 20 weight percent first polymer, 1 to 25 weight percent polar monomers, and 55 to 94 weight percent alkyl (meth)acrylates or 5 to 20 weight percent first polymer, 1 to 15 weight percent polar monomers, and 65 to 94 weight percent alkyl (meth)acrylates. In still other examples, the syrup composition contains 1 to 15 weight percent first polymer, 1 to 30 weight percent polar monomers, and 55 to 98 weight percent alkyl (meth)acrylate or 1 to 15 weight percent first polymer, 1 to 20 weight percent polar monomers, and to 98 weight percent alkyl (meth)acrylate. In yet another example, the syrup composition contains 1 to 10 weight percent first polymer, 1 to 30 weight percent polar monomers, and 60 to 98 weight percent alkyl (meth)acrylate or 1 to 10 weight percent first polymer, 1 to 15 weight percent polar monomers, and 75 to 98 weight percent alkyl (meth)acrylate.

The first polymer (i.e., solute polymer) typically has a weight average molecular weight of at least 100,000 Daltons. For example, the weight average molecular weight can be at least 200,000 Daltons, at least 300,00 Daltons, at least 400,000 Daltons, at least 500,000 Daltons, or at least 600,000 Daltons and up to 1,000,000 Daltons, up to 2,000,000 Daltons, or up to 3,000,000 Daltons or even higher. The weight average molecular weight can be determined using size exclusion chromatography (SEC) with polystyrene standards.

The first polymer is usually not crosslinked but can be crosslinked depending on the selection of the crosslinking agent included in the second polymerizable composition.

### Second Polymerizable Composition

The second polymer is formed from a second polymerizable composition that includes (a) an alkyl (meth)acrylate, (b) a polar monomer, (c) a polyether (meth)acrylamide macromer, and (d) a crosslinking agent. The second polymer, which is crosslinked, can be formed in the presence or absence of the first polymer.

In some embodiments, the second polymer can be formed in the presence of the first polymer. That is, the second polymerizable composition can further include the first polymer. If the first polymer is present, it is typically part of a syrup composition formed from the first polymerizable composition. Alternatively, in other embodiments, the second polymerizable composition can be prepared that does not include either a syrup composition or the first polymer.

Typically, the second polymerizable composition contains (a) a syrup composition formed from a first polymerizable composition comprising (i) an alkyl (meth)acrylate and (ii) an optional polar monomer, (b) a polar monomer if the syrup composition is free of the optional polar monomer (or if additional polar monomer is desired), (c) a polyether (meth)acrylamide macromer, and (d) a crosslinking agent having a plurality of (meth)acryloyl groups. The syrup composition contains (a) 1 to 20 weight percent solute polymer having a weight average molecular weight of at least 100,000 Daltons and that is the first polymer and (b) 80 to 99 weight percent solvent monomers. The polymerized product of the second polymerizable composition contains the first polymer plus a second polymer that is crosslinked. Because the first polymer is not a living polymer, it does not polymerize further during the polymerization of the second polymerizable composition to form the second polymer (although, depending on the crosslinking agent in the second polymerizable composition, the first polymer may undergo crosslinking). Thus, the polymerized product of the second polymerizable composition is a polymeric blend of the first and second polymers.

The alkyl (meth)acrylate monomers that can be used for preparation of the second polymer can be the same as those described for use in the preparation of the first polymer. In some embodiments, at least some of the alkyl (meth)acrylate monomers included in the second polymerizable composition are the unreacted solvent monomers in the syrup composition formed by partial polymerization of the first polymerizable composition. Additional amounts of the alkyl (meth)acrylate monomers used to form the first polymer or other types of these monomers can be added to the second polymerizable composition, if desired.

The second polymerizable composition typically include 25 to 95 weight percent alkyl (meth)acrylate monomers based on a total weight of polymerizable components in the second polymerizable composition. The amount of the alkyl (meth)acrylate can be at least 25 weight percent, at least 30 weight percent, at least 35 weight percent, at least 40 weight percent, at least 45 weight percent, at least 50 weight percent, at least 55 weight percent, at least 60 weight percent, at least 65 weight percent, or at least 70 weight percent and up to 95 weight percent, up to 90 weight percent, up to 85 weight percent, up to 80 weight percent, up to 75 weight percent, up to 70 weight percent, up to 65 weight percent, or up to 60 weight percent. The amount is based on the total weight of polymerizable components in the second polymerizable composition.

The polar monomers that can be used for the preparation of the second polymer can be the same as those described as optional polar monomers for use in the preparation of the first polymer. In some embodiments, at least some of the polar monomers included in the second polymerizable composition are the unreacted polar monomers in the syrup composition formed by partial polymerization of the first polymerizable composition. That is, the first polymerizable composition contained polar monomers. If polar monomers were included in the first polymerizable composition, additional polar monomers can be added to the second polymerizable monomer, if desired. These additional polar monomers can be the same or different than those included in the first polymerizable composition. If polar monomers were not included in the first polymerizable composition, they are typically included in the second polymerizable composition.

The second polymerizable composition typically includes 0.5 to 40 weight percent polar monomer based on a total weight of polymerizable components in the second polymerizable composition. The amount of the polar monomer can be at least 0.5 weight percent, at least 1 weight percent, at least 2 weight percent, at least 3 weight percent, at least 5 weight percent, or at least 10 weight percent and up to 40 weight percent, up to 35 weight percent, up to 30 weight percent, up to 25 weight percent, up to 20 weight percent, up to 15 weight percent, up to 10 weight percent, or up to 5 weight percent. The polar monomer can be an acidic monomer, a non-acidic monomer, or a combination thereof. As in the first polymerizable composition, the amount of a polar monomer having an acidic group is usually no greater than 30 weight percent, no greater than 25 weight percent, no greater than 20 weight percent, no greater than 15 weight percent, no greater than 10 weight percent, or no greater than 5 weight percent based on the total weight of polymerizable components in the second polymerizable composition.

In addition to the alkyl (meth)acrylate and the polar monomer, the second polymerizable composition includes a polyether (meth)acrylamide macromer. That is, the macromer has a polyether group. The polyether group contains at least 50 mole percent propylene oxide based on total moles of alkylene oxide in the polyether group. Thus, the polyether (meth)acrylamide macromers is selected from (i) (meth)acrylamide macromers having a poly(propylene oxide) group, (ii) (meth)acrylamide macromers having a poly(ethylene oxide-co-propylene oxide) group that contains at least 50 mole propylene oxide based on a total moles of alkylene oxide in the polyether group, or (iii) a mixture of different polyether (meth)acrylamide monomers wherein at least 50 mole percent of the alkylene oxide in all the polyether groups is propylene oxide.

The amount of alkylene oxide that is propylene oxide in either the (meth)acrylamide macromers having a poly(ethylene oxide-co-propylene oxide) group or in the mixture of different polyether (meth)acrylamide monomers is at least 50 mole percent, at least 55 mole percent, at least 60 mole percent, at least 65 mole percent, at least 70 mole percent, at least 75 mole percent, at least 80 mole percent, at least 85 mole percent, at least 90 mole percent and up to 100 mole percent, up to 95 mole percent, up to 90 mole percent, up to 85 mole percent, up to 80 mole percent, up to 75 mole percent, or up to 70 mole percent. The mole percent amounts are based on total moles of alkylene oxide in the one or more polyether (meth)acrylamide macromers.

The polyether (meth)acrylamide macromer can be prepared, for example, by reacting a monofunctional amine terminated polyether compound with (meth)acryloyl chloride. Suitable monofunctional amine terminated polyether compounds having a suitable propylene oxide content are available commercially under the trade designation JEFFAMINE (e.g., JEFFAMINE M600, M1000, and M2005 from Huntsman (Houston, TX, USA)).

The weight average molecular weight of the polyether (meth)acrylamide macromer is typically in a range of 300 to 12,000 Daltons, which can be determined using known methods such as size exclusion chromatography with polystyrene standards or by NMR (e.g., see example section). If the molecular weight is higher, it may not be miscible with the other components such as the syrup composition in the second polymerizable composition and/or crystallize before, during, or after polymerization of the second polymer. Additionally, the polyether (meth)acrylamide macromer is often selected so that the polyether sidechains do not undergo microphase separation from the remainder of the second polymer. In many embodiments, the polyether (meth)acrylamide macromer has a weight average molecular weight of at least 500 Daltons, at least 600 Daltons, at least 800 Daltons, at least 1,000 Daltons, at least 2,000 Daltons, or at least 3,000 Daltons and up to 12,000 Daltons, up to 10,000 Daltons, up to 8,000 Daltons, up to 6,000 Daltons, up to 5,000 Daltons, or up to 3,000 Daltons.

The polyether (meth)acrylamide macromer often has a glass transition temperature (as measured using a homopolymer of the macromer) that is no greater than −10° C. For example, the glass transition temperature can be no greater than −20° C., no greater than −30° C., no greater than −40° C., no greater than −50° C., or no greater than −60° C. Such a low macromer glass transition temperature imparts compliance and flexibility to the adhesive composition containing the first and second polymers. The polyether (meth)acrylamide macromer can be crystalline or non-crystalline provided that the adhesive composition is not crystalline.

The second polymerizable composition typically include 2 to 50 weight percent polyether (meth)acrylamide macromer based on a total weight of polymerizable components in the second polymerizable composition. The amount can be at least 2 weight percent, at least 3 weight percent, at least 5 weight percent, at least 10 weight percent, at least 15 weight percent, or at least weight percent and up to 50 weight percent, up to 45 weight percent, up to 40 weight percent, up to 35 weight percent, up to 30 weight percent, up to 25 weight percent, up to 20 weight percent, up to 15 weight percent, or up to 10 weight percent. The amount is based on the total weight of polymerizable components in the second polymerizable composition.

The second polymerizable composition further includes a crosslinking agent. That is, the second polymer is crosslinked. Typically, such crosslinking improves durability and cohesion properties of the adhesive composition. Depending on the choice of the crosslinking agent and whether the second polymer is formed in the presence of the first polymer, the crosslinking agent included in the second polymerizable composition may result in crosslinking of only the second polymer or crosslinking of both the first and the second polymers.

Suitable crosslinking agents for use in the second polymerizable composition include, but are not limited to, multifunctional (meth)acrylate monomers or multifunctional (meth)acrylamide monomers, aziridine crosslinkers, and various thermal or photoactive crosslinkers. Examples of aziridine crosslinkers include, but are not limited to, 1,1′-isophthaloyl-bis(2-methylaziridine) and trimethylolpropane tris(2-methyl-1-aziridine propionate).

Examples of suitable thermal and photoactive crosslinkers include, but are not limited to, organic peroxides, benzophenone derivatives such as 4-benzoylphenyl acrylate, azide-containing compounds such as 2,6-bis(4-azidobenzylidene)cyclohexanone, and bis-diazirines. The use of aziridine crosslinkers and the thermal or photoactive crosslinkers can result in crosslinking of both the first and second polymers. Use of the multifunctional (meth)acrylate or multifunctional (meth)acrylamide crosslinkers typically results in the crosslinking of the second polymer but not the first polymer.

In many embodiments, the crosslinking agent is a multifunctional (meth)acrylate monomer. Such crosslinking agents have a plurality of (meth)acryloyl groups (e.g., 2, 3, or 4 (meth)acryloyl groups). The number of (meth)acryloyl groups is typically 2, 3, or 4. Examples of multifunctional (meth)acrylate monomer crosslinking agents include, but are not limited to, 1,3-butylene glycol diacrylate, 1,4-butanediol diacrylate, 1,6-hexanediol diacrylate, ethoxylated bisphenol A diacrylate, tetraethylene glycol diacrylate, and trimethyloyl propane triacrylate.

The polymerizable components of the second polymerizable composition often contain 0.01 to 5 weight percent of the crosslinking agent. The amount can be at least 0.01 weight percent, at least 0.05 weight percent, at least 0.1 weight percent, at least 0.2 weight percent, at least 0.3 weight percent, at least 0.5 weight percent, or at least 1 weight percent and up to 5 weight percent, up to 4 weight percent, up to 3 weight percent, up to 2 weight percent, or up to 1 weight percent based on the total weight of polymerizable components in the second polymerizable composition. The amount of the crosslinking agent included depends on well-understood factors such as the desired degree of crosslinking and/or the relative effectiveness of the crosslinking agent in the specific system, as measured by well-known tests such as shear adhesion.

The second polymerizable composition is usually free of a multivalent salt that can function as a crosslinking agent. Using a crosslinking agent that can form covalent bonds (rather than ionic bonds) with the second polymer tends to result in the formation of adhesive compositions with improved shear strength, especially at elevated temperatures.

Other components can be added to the second reaction polymerizable composition such as any of the initiators, chain transfer agents, and non-reactive organic solvents described above for use in the first polymerizable composition. The amount of these components is comparable to that described for use in the first polymerizable composition.

Considering only the polymerizable components, which excludes the first polymer either because it does not undergo further polymerization or because it is absent, the second polymerizable composition typically contains 0.5 to 40 weight percent polar monomers, 25 to 95 weight percent alkyl (meth)acrylate monomers, 2 to 50 weight percent polyether (meth)acrylamide macromer, and 0.01 to 5 weight percent crosslinking agent based on the total weight of polymerizable components in the second polymerizable composition. For example, the second polymerizable composition can contain 1 to 30 weight percent polar monomers, 30 to 95 weight percent alkyl (meth)acrylate monomers, 4 to 40 weight percent polyether (meth)acrylamide macromer, and 0.01 to 5 (or 0.01 to 1) weight percent crosslinking agent. In another example, the second polymerizable composition can contain 1 to 20 weight percent polar monomers, 40 to 90 weight percent alkyl (meth)acrylate monomers, 4 to 40 weight percent polyether (meth)acrylamide macromer, and 0.01 to 5 (or 0.01 to 1) weight percent crosslinking agent. In yet another example, the second polymerizable composition can contain 1 to 15 weight percent polar monomers, 55 to weight percent alkyl (meth)acrylate monomers, 5 to 30 weight percent polyether (meth)acrylamide macromer, and 0.01 to 5 (or 0.01 to 1) weight percent crosslinking agent. The amounts are based on the total weight of polymerizable components in the second polymerizable composition.

If the second polymerizable composition includes a syrup composition containing the first polymer as the solute polymer and unreacted syrup monomers, the second polymerizable composition usually contains 50 to 98 weight percent syrup composition, 2 to 50 weight percent polyether (meth)acrylamide macromer, and 0.01 to 5 weight percent crosslinking agent. If the syrup composition is free of polar monomer, 0.5 to 40 weight percent polar monomers is added. Considering the content of the syrup composition, the second polymerizable composition typically contains 0.5 to 20 weight percent first polymer (i.e., the solute polymer in the syrup composition), 0.5 to 40 weight percent polar monomers, 25 to 95 weight percent alkyl (meth)acrylate monomers, 2 to 50 weight percent polyether (meth)acrylamide macromer, and 0.01 to 5 weight percent crosslinking agent. The amounts are based on the total weight of the second polymerizable composition.

In some examples, the second polymerizable composition contains 1 to 20 weight percent first polymer (i.e., the solute polymer in the syrup composition), 1 to 40 weight percent polar monomers, 25 to 95 weight percent alkyl (meth)acrylate monomers, 4 to 40 weight percent polyether (meth)acrylamide macromer, and 0.01 to 5 (or 0.01 to 1) weight percent crosslinking agent. In still other examples, the second polymerizable composition contains 5 to 20 weight percent first polymer (i.e., the solute polymer in the syrup composition), 1 to 30 weight percent polar monomers, 40 to 90 weight percent alkyl (meth)acrylate monomers, 4 to 40 weight percent polyether (meth)acrylamide macromer, and 0.01 to 5 (or 0.01 to 1) weight percent crosslinking agent. In yet further examples, the second polymerizable composition contains 5 to 15 weight percent first polymer (i.e., the solute polymer in the syrup composition), 1 to 20 weight percent polar monomers, 50 to 90 weight percent alkyl (meth)acrylate monomers, 5 to 30 weight percent polyether (meth)acrylamide macromer, and 0.01 to 5 (or 0.01 to 1) weight percent crosslinking agent. The amounts are based on the total weight of the second polymerizable composition.

Like the first polymerizable composition, the second polymerizable composition can be polymerized by exposure of the second polymerizable composition to actinic radiation, which is often ultraviolet radiation, or to heat (e.g., 40 to 100 degrees Celsius).

### Adhesive Composition and Method of Making

An adhesive composition is provided that includes both a first polymer plus a second polymer. The adhesive composition contains 0.5 to 20 weight percent of the first polymer and 80 to 99.5 weight percent of the second polymer based on a total weight of polymeric material in the adhesive composition. The first polymer has a weight average molecular weight of at least 100,000 Daltons and is a polymerized product of a first polymerizable composition comprising (a) an alkyl (meth)acrylate and (b) an optional polar monomer. The second polymer is a polymerized product of a second polymerizable composition comprising (a) an alkyl (meth)acrylate, (b) a polar monomer, (c) a polyether (meth)acrylamide macromer, and (d) a crosslinking agent. The second polymer is crosslinked, but the first polymer can be either crosslinked or not crosslinked.

Any method of making the adhesive composition can be used. In many embodiments, the method includes polymerizing the second polymer in the presence of the first polymer. More specifically, the method includes providing a first polymerizable composition that comprises (a) an alkyl (meth)acrylate and (b) an optional polar monomer. The method further includes forming a syrup composition by partially polymerizing the first polymerizable composition. The syrup composition contains (a) 1 to 20 weight percent solute polymer and (b) 80 to 99 weight percent solvent monomers based on a total weight of the syrup composition. The solute polymer has a weight average molecular weight of at least 100,000 Daltons and is a first polymer. The method yet further includes preparing a second polymerizable composition comprising (a) the syrup composition, (b) a polar monomer if the syrup composition is free of the optional polar monomer or if additional polar monomer is desired, (c) a polyether (meth)acrylamide macromer, and (d) a crosslinking agent. The method still further includes polymerizing the second polymerizable composition to form an adhesive composition comprising the first polymer plus a second polymer. The second polymer is crosslinked, but the first polymer can be either crosslinked or not crosslinked depending on the selection of the crosslinking agent. The adhesive composition is typically a pressure-sensitive adhesive.

In some embodiments, the second polymerizable composition is coated on a substrate and then cured on the substrate. The substrate can be in the form of a moving web that is passed through an oven (e.g., 40 to 100 degrees Celsius) or under ultraviolet radiation for polymerization (i.e., curing) of the second polymerizable composition.

The adhesive composition typically contains 0.5 to 20 weight percent of the first polymer and 80 to 99.5 weight percent of the second polymer based on a total weight of polymeric material in the adhesive composition. For example, the adhesive composition can include 1 to 20 weight percent first polymer and 80 to 99 weight percent second polymer, 2 to 20 weight percent first polymer and 80 to 98 weight percent second polymer, 5 to 20 weight percent first polymer and 80 to 95 weight percent second polymer, or 5 to 15 weight percent first polymer and 85 to 95 weight percent second polymer based on the total weight of polymeric material in the adhesive composition.

The adhesive composition can contain other optional components in addition to the first and second polymers. The combination of the first and second polymers may have adhesive properties suitable for performing as a pressure-sensitive adhesive. Alternatively, optional additives such as a tackifier and/or plasticizer may be combined with the first and second polymers to provide a composition with suitable adhesive properties. Useful tackifiers include, for example, rosin ester resins, terpene phenol resins, and hydrogenated C5-C9 hydrocarbon resins. The amount of the optional tackifier is often in a range of 0 to 25 weight percent, 0 to 20 weight percent, 0 to weight percent, 0 to 10 weight percent, or 0 to 5 weight percent based on the total weight of the first and second polymers (or their polymerizable components).

Optional antioxidants and/or stabilizers such as those available under the trade designation IRGANOX 1010 (pentaerythritol tetrakis(3-(3,5-di-tert-butyl-4-hydroxyphenyl)propionate)) from BASF Corp. (Florham Park, NJ, USA) can be added to increase the temperature stability of the first and/or second polymers. If used, the antioxidant and/or stabilizer is typically added in a range of 0.01 weight percent to 1.0 weight percent on the total weight of the first and second polymers (or their polymerizable components).

Various other optional components can be added to the adhesive composition such as, for example, adhesion promoters (e.g., (3-glycidyloxypropyl)trimethoxysilane or (3-glycidyloxypropyl)triethoxysilane), colorants (e.g., titania or carbon black), dyes, corrosion inhibiters (e.g., benzotriazole), antistatic agents, plasticizers, thickeners, thixotropic agents, processing aides, nanoparticles, fibers, fillers, and combinations thereof. Generally, the amounts of each additive would depend on the use of the adhesive composition.

The adhesive composition typically has a glass transition temperature no greater than ° C. or 20° C. as determined by Dynamic Mechanical Analysis. For example, the glass transition temperature can be no greater than −20° C., no greater than −25° C., no greater than −30° C., no greater than −35° C., or no greater than −40° C. The glass transition temperature is often greater than −50° C., greater than −40° C., or greater than −30° C. In some embodiments, the glass transition temperature is in a range of −30° C. to 0° C. The glass transition temperature can be measured using Dynamic Mechanical Analysis. The DMA scan often contains a single peak.

The peel adhesion is typically reduced by less than 50 percent after being stored for two weeks at 65° C. and 90 percent relative humidity compared to being stored for one day at 21° C. and percent relative humidity. For example, the reduction can be less than 40 percent, less than 35 percent, less than 30 percent, less than 25 percent, less than 20 percent, less than 15 percent, or less than 10 percent.

### Articles

Articles are provided that include the adhesive composition and a substrate. Any suitable substrate can be used. In many embodiments, a layer of the adhesive composition is positioned adjacent to the substrate. The adhesive composition may directly contact the substrate or may be separated from the substrate by one of more layers such as a primer layer.

Any suitable substrate can be used. In some articles, the substrate is flexible. Examples of flexible substrate materials include, but are not limited to, polymeric films, woven or nonwoven fabrics; metal foils, foams (e.g., polyacrylic, polyethylene, polyurethane), and combinations thereof (e.g., metalized polymeric film). Polymeric films include, for example, polypropylene (e.g., biaxially oriented), polyethylene (e.g., high density or low density), polyvinyl chloride, polyurethane (e.g., thermoplastic polyurethanes), polyester (e.g., polyethylene terephthalate (PET), polyethylene naphthalate (PEN), and polylactic acid copolymer), polycarbonate, polyacrylate, polymethyl(meth)acrylate (PMMA), polyvinylbutyral, polyimide, polyamide, fluoropolymer, cellulose acetate, triacetyl cellulose (TAC), ethyl cellulose, and polycyclic olefin polymers (COP). The woven or nonwoven fabric may include fibers or filaments of synthetic or natural materials, such as cellulose, cotton, nylon, rayon, glass, ceramic materials, and the like.

In some embodiments, the article is or contains an adhesive tape. Examples of such adhesive tapes include transfer tapes, one-sided adhesive tapes, two-sided tapes (i.e., a core substrate with an adhesive layer on each side of the substrate, or die-cut adhesive articles (e.g. the article has an adhesive layer positioned adjacent to one release liner or positioned between two release liners). Such adhesive tapes may include a wide variety of substrates for use as a backing or release liner. Examples include woven and nonwoven materials, plastic films, metal foils, and the like.

Adhesive tapes are often prepared by coating the second polymerizable composition upon a variety of flexible or inflexible backing materials and/or release liners using conventional coating techniques to produce a one-sided tape or a two-sided tape. The second polymerizable composition is often cured while on backing material and/or release liner to form the adhesive composition. In the case of a one-sided adhesive tape, the second polymerizable composition can be coated on a layer of backing material and the side of the backing material opposite that where the adhesive is disposed can be coated with a suitable release material (e.g., a release layer or release liner). Release materials are known and include materials such as, for example, silicone, polyethylene, polycarbamate, polyacrylics, and the like. For two-sided adhesive tape, a first adhesive composition layer is on a first major surface of a backing material and a second layer of adhesive composition is on the opposing major surface of the backing material. The second layer may include the adhesive compositions as described herein or a different adhesive composition. For a die-cut adhesive article or for a transfer tape, the adhesive composition is typically positioned between two release liners.

The adhesive articles can be part of another article. For example, the adhesive composition can bind two parts of an article together. In some such articles, the adhesive is positioned adjacent to a substrate that is flexible and/or foldable and is used within another article that is flexible and/or foldable such as within an electronic device that is flexible and/or foldable.

In some embodiments, the article containing the adhesive composition is part of an electronic device. In such devices, the adhesive composition typically forms a layer between two substrates for binding of the two substrates together. Examples of suitable substrates include materials such as polyacrylate, polymethyl methacrylate, polycarbonate, polyamide, polyimide, polyethylene terephthalate (PET), polyethylene naphthalate (PEN), polycyclic olefin polymers (COP), thermoplastic polyurethane, triacetyl cellulose (TAC), and metal foil.

A common application of adhesives in the electronics industry is in the manufacturing of various displays such as computer monitors, TVs, cell phones, small displays (in cars, appliances, wearables, electronic equipment, etc.). Flexible electronic displays, where the display can be bent freely without cracking or breaking, is a rapidly emerging technology area for making electronic devices using, for example, flexible plastic substrates. This technology allows integration of electronic functionality into non-planar objects, conformity to desired design, and flexibility during use that can give rise to a multitude of new applications. Thus, in some embodiments, the electronic device includes a flexible display.

With the emergence of flexible electronic displays, there is an increasing demand for adhesives, and particularly for optically clear adhesives (OCA), to serve as an assembly layer or gap filling layer between an outer cover lens or sheet (based on glass, polyethylene terephthalate (PET), polycarbonate (PC), polymethyl methacrylate (PMMA), polyimide, polyethylene naphthalate (PEN), cyclic olefin copolymer, etc.) and an underlying display module of electronic display assemblies. The presence of the OCA improves the performance of the display by increasing brightness and contrast, while also providing structural support to the assembly. In a flexible assembly, the OCA will also serve as the assembly layer, which in addition to the typical OCA functions, may also absorb most of the folding induced stress to prevent damage to the fragile components of the display panel and protect the electronic components from breaking under the stress of folding. The OCA layer may also be used to position and retain the neutral bending axis at or at least near the fragile components of the display, such as for example the barrier layers, the driving electrodes, or the thin film transistors of an organic light emitting display (OLED). The adhesive compositions described herein can be prepared to be an OCA.

In some embodiments, the electronic device includes a photovoltaic device. Photovoltaic devices are rapidly advancing in performance and device construction. The ability to roll or fold portable arrays is an attractive design for off grid uses such as remote area travel or living, camping, and mobile applications. As the photovoltaic (PV) components become more efficient, the number of modules needed to produce enough power decreases, reducing both size and weight. Integrating organic PV cells or inorganic PV cells onto or into a flexible format offer advantageous designs.

Other flexible articles that can include the adhesive composition described herein include, for example, rollable keyboards, electronic games, sensors, light-emitting elements, and articles of clothing.

The article is often formed by positioning an adhesive layer adjacent to a substrate. The adhesive composition is often formed from the second polymerizable composition that is coated on a substrate (e.g., a backing or a release liner) using conventional coating techniques and then cured. For example, the second polymerizable composition can be applied by methods such as roller coating, flow coating, dip coating, spin coating, spray coating, and die coating. The adhesive composition that is coated may have any desirable weight percent solids but is often in a range of 10 to 100 weight percent solids based on the total weight of the adhesive composition. The desired solids content may be achieved by further dilution of the coating composition, or by partial drying. The second polymerizable composition is usually cured by actinic radiation (e.g., radiation in the UV and/or visible region of the electromagnetic spectrum) or by application of heat.

The adhesive composition positioned on a substrate as a layer or positioned between two release liners as a layer often has a thickness up to 100 micrometers (i.e., microns or μm), up to 50 micrometers, up to 35 micrometers, or up to 25 micrometers. In some embodiments, the adhesive composition may have an overall (average) thickness of the adhesive composition disposed on a substrate in a layer (e.g., in the form of a coating placed between liners) of up to 400 micrometers, up to 300 micrometers, or up to 200 micrometers. The thickness that is desirable is dependent on the specific use of the adhesive layer.

### Examples

Unless otherwise noted or readily apparent from the context, all parts, percentages, ratios, etc. in the Examples and the rest of the specification are by weight.

TABLE 1
Materials Used in the Examples

| Abbreviation | Description and Source |
|---|---|
| 2-EHA | 2-Ethylhexyl acrylate, available from BASF, Ludwigshafen, Germany |
| IBOA | Isobornyl acrylate, available from San Esters, New York, NY |
| AA | Acrylic acid, available from BASF, Ludwigshafen, Germany |
| NNDMA | N,N-dimethylacrylamide, obtained from TCI America, Portland, OR |
| HDDA | 1,6-hexanediol diacrylate, obtained from Arkema, Paris, France |
| 2-MBA | 2-Methylbutyl acrylate, obtained from 3M Company, St. Paul, MN |
| 550 MPEG-A | Poly(ethylene glycol)-methyl ether acrylate, Mn = 550 Da obtained |
| | from Sans Esters, Osaka, Japan |
| 1000 MPEG-A | Poly(ethylene glycol)-methyl ether acrylate, Mn = 1000 Da, obtained |
| | from Sans Esters, Osaka, Japan |
| 500 PPG-A | Poly(propylene glycol) acrylate, Mn = 495 Da obtained from |
| | Millipore Sigma, Burlington, MA |
| M600 | A moderately hydrophobic polyether monoamine of approximately |
| | 600 Da molecular weight, obtained under the trade designation |
| | “JEFFAMINE M-600”, available from Huntsman, Houston, TX. The |
| | polyether group contains both polypropylene oxide units and ethylene |
| | oxide units in a 9:1 molar ratio. |
| M1000 | A hydrophilic polyether monoamine of approximately 1000 Da |
| | molecular weight, obtained under the trade designation “JEFFAMINE |
| | M-1000”, available from Huntsman, Houston, TX. The polyether |
| | group contains both polypropylene oxide units and ethylene oxide |
| | units in a 3:19 molar ratio. |
| M2005 | A moderately hydrophobic polyether monoamine of approximately |
| | 2000 Da molecular weight, obtained under the trade designation |
| | “JEFFAMINE M-2005”, available from Huntsman, Houston, TX. |
| | The polyether group contains both polypropylene oxide units and |
| | ethylene oxide units in a 29:6 molar ratio. |
| M600-ACM | An acrylamide terminated macromer, synthesized herein from M600 |
| M1000-ACM | An acrylamide terminated macromer, synthesized herein from M1000 |
| M2005-ACM | An acrylamide terminated macromer, synthesized herein from M2005 |
| IRG 651 | 2,2-dimethoxy-2-phenylacetophenone, obtained under the trade |
| | designation “IRGACURE 651”, obtained from Ciba Specialty |
| | Chemicals, Basel, Switzerland |
| DCM | Dichloromethane, obtained from Fisher Scientific International Inc., |
| | Hampton, NH (distilled from CaH₂ prior to use) |
| | Acryloyl Chloride, obtained from Millipore Sigma, Burlington, MA |
| TEA | Triethylamine, obtained from Millipore Sigma, Burlington, MA |
| | (distilled from KOH prior to use) |
| MgSO₄ | Magnesium sulfate, Millipore Sigma, Burlington, MA |
| | Silica gel 60, obtained Alfa Aesar, Ward Hill, MA |
| EO | Ethylene oxide |
| PO | Polypropylene oxide |

### Test Methods

### Peel Adhesion Testing

Peel adhesion was measured for PSA transfer tapes (ATTs) at an angle of 180° on an SP-2100 iMass (iMass Inc., Accord, MA USA). Peel tests were conducted at a rate of 12 inches/min (0.3 m/min) cross-head speed at a temperature of 23° C., before or after ageing at 65° C./90% RH for extended time. Each sample was peeled at least three times from the same SS substrate and averages of all three measurements are reported. For peel adhesion testing to rigid substrates such as annealed 18 gauge, 304 stainless steel (SS), polypropylene (PP), (both from Chem. Instruments, Fairfield, OH), the ATTs were laminated directly to the 2-inch×6-inch (5.08 cm×15.24 cm) substrate. This method followed ASTM D3330, test method E, liner side, and TM-613 (180° peel adhesion to stainless steel or backing) procedure F. PSA ATTs were laminated to the plasma-treated side of 2 mil (50 μm) biaxially oriented polyethylene terephthalate (PET) film (3M, treatment conditions are described in U.S. Pat. No. 10,134,566) for use as a backing material. All samples and substrates were conditioned in a controlled temperature and humidity (CTH) room (23° C.), 50% RH) for a period of no less than 24 hours prior to testing. Test panels (besides PP) were cleaned with methyl ethyl ketone (Millipore Sigma, Burlington, MA) before and after testing. A rubberized 4.5-lb (2.04 Kg) roller was used to laminate the PET tapes to the panels (4×3 sec roll downs).

### Rheology

Rheological testing was performed on an TA Instruments DHR-3 (New Castle, DE). All data was collected by heating/cooling at a rate of 3° C./min at oscillatory frequencies of 1 Hz with strain values in the linear viscoelastic regime (typically <5%).

### Molecular Weight by Size Exclusion Chromatography (SEC)

Molar masses were determined on a Waters e2695 separations module SEC equipped with 2414 RI and 2489 UV Vis detectors. The separations were conducted using a Styragel Guard Column, 20 μm, 4.6 mm×30 mm in combination with Styragel Column, HR 5E, mixed bed, 5 μm, 7.8 mm×300 mm, 2K-4M). Sample was passed through the columns at a flow rate of 1.0 milliliter per minute using a THF mobile phase. Data were processed in Empower software and molar masses are reported relative to polystyrene standards.

### Number Average Molecular Weight by NMR

Nuclear Magnetic Resonance Spectroscopy was performed on a Bruker 500 MHz instrument. 1H-NMR was in CDCl3 (residual solvent referenced to 7.26 ppm). The number average molecular weight was calculated by setting the terminal PO unit —CH3 signal at 1.0 ppm to 3.0.

### Preparatory Examples: Synthesis of Acrylamide Macromers:

The various JEFFAMINE samples obtained from Huntsman are monofunctional amine terminated copolymers of propylene glycol and ethylene glycol. The chemical compositions and molecular weight data are shown in Table 2.

TABLE 2
Chemical composition of JEFFAMINE polyether monoamines

| | | Vendor Reported | ¹H-NMR Number |
|---|---|---|---|
| | | Number Average | Average Molecular |
| | PO:EO | Molecular Weight | Weight |
| JEFFAMINE | molar ratio | (kDa) | (kDa) |
| M-600 | 9:1 | 0.6 | 0.56 |
| M-1000 | 3:19 | 1 | 098 |
| M-2005 | 29:6 | 2 | 1.89 |

The acrylamide macromers used in this study were prepared by the reaction of the amine terminated JEFFAMINE with acryloyl chloride. An example reaction is shown in Scheme 1 where R is hydrogen or —CH₃ and n is an integer equal to at least 3. The synthesis of macromer M1000-ACM is described below and is representative of all the other macromers that were synthesized.

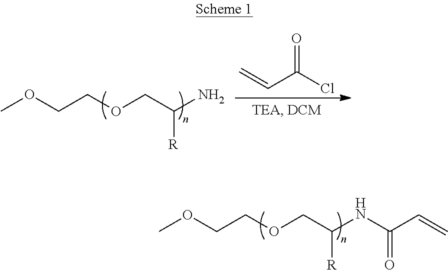

Under nitrogen, a dry round bottom flask with magnetic stir bar was charged with JEFFAMINE M-1000 (60.04 g, 60 mmol, 1 eq.) and DCM (280 g). The solution was set stirring and cooled to 0° C. in an ice bath. Triethylamine (10 mL, 72 mmol, 1.2 eq) was added followed by acryloyl chloride (5.8 mL, 72 mmol, 1.2 eq.) by dropwise addition. The reaction mixture was allowed to warm to room temperature and stirred for 16 hours. The salt precipitate was filtered and the resulting solution was washed with an equivalent volume amount of water (2×) and brine (1×) in a separatory funnel. The organic phase was dried over MgSO₄ and the solvent was removed by rotary evaporation. The crude reaction product was loaded onto a column of 50 weight percent (250 grams) basic alumina (top half of column) and 50 weight percent (250 gams) silica (bottom half of column) and eluted using a gradient of dichloromethane and methanol. Removal of the solvent in by rotary evaporation yielded 34.1 g of M1000-ACM.

### Examples: Preparation and Characterization of Adhesive Compositions and Adhesive Tapes

Monomers were combined in the appropriate wt-% ratios to target the desired final copolymer composition, with a total wt-% of 100% by mass as shown in Table 3 and 4. All other components added were based on the weight of the first monomer composition and are reported as parts per hundred resin (phr).

Specifically, two syrup compositions were prepared. The first syrup was prepared from a monomer mixture of 2-EHA/2-MBA/IBOA/AA/NNDMA (41%/41%/6%/10%/2%) and was used to prepare the polymeric material in Table 3. The second syrup was prepared from a monomer mixture of 2-EHA/2-MBA/NNDMA (45/40/15) and was used to prepare the polymeric material in Table 4. To each monomer mixture was added IRGACURE 651 at 0.02 phr (with respect to the total mass of 100 wt-% of the monomers). The mixture of monomers and initiator was degassed with nitrogen for 10 min, and then exposed to low intensity (0.3 mW/cm2) UV-A radiation from a 360 nm UV-LED light source, while stirring until a syrup composition having a viscosity of approximately 1000-2000 cP was obtained. The molecular weight of each syrup polymer was measured by the SEC method. The first syrup had a number average molecular weight of about 3.66 MDa (3,660,000 Da), a weight average molecular weight of about 7.68 MDa, and a Dispersity Index of about 2.1. These were approximate values because the molecular weight exceeded 1 MDa and was outside the range covered by the calibration curve (the values reported are likely to be an under estimation of the molecular weight). The second syrup had a number average molecular weight of 1.03 MDa, a weight average molecular weight of 2.38 MDa, and a Dispersity Index of 2.3.

IRGACURE 651 (0.2 phr), HDDA (0.10 phr) and macromonomer (1520 phr, see Tables 3 and 4) was added to each syrup composition, and the solution was well mixed. The solution was coated between PET release liners (Tight side: RF22N or RF12N and easy side: RF02N; all available from SKC Haas, Seoul, Korea, 2 mil). The coated solutions were cured with 1,600 mJ/cm² of total UV-A 365 nm UV-LED irradiation to produce tacky adhesive films.

For adhesive performance testing, the RF02N liner was removed, and the exposed side of the tacky adhesive tape was rolled by hand lamination (using a 6-inch (15-cm) rubberized hand roller, Polymag Tek, NY) onto a 6-inch (15-cm) wide primed polyester film (3M, 2-mil (50-μm) biaxially oriented PET film with plasma treatment conditions described in U.S. Pat. No. 10,134,566) ensuring no air bubbles were trapped between the adhesive and the primed polyester film.

TABLE 3
Examples made using a base syrup composition (100
phr) of 2-EHA/2-MBA/IBOA/AA/NNDMA (41/41/6/10/2)

| | | | | IRG 651 | HDDA |
|---|---|---|---|---|---|
| Example | Macromonomer | mole % EO | phr | (phr) | (phr) |
| EX1 | M600-ACM | 10 | 20 | 0.2 | 0.1 |
| EX2 | M2005-ACM | 17 | 20 | 0.2 | 0.1 |
| CE1 | 550 MPEG-A | 100 | 20 | 0.2 | 0.1 |
| CE2 | 1000 MPEG-A | 100 | 20 | 0.2 | 0.1 |
| CE3 | 500 PPG-A | 0 | 20 | 0.2 | 0.05 |
| CE4 | 500 PPG-A | 0 | 15.6 | 0.2 | 0.05 |
| CE5 | M1000-ACM | 86 | 20 | 0.2 | 0.1 |

TABLE 4
Examples made using a base syrup composition
(100 phr) of 2-EHA/2-MBA/NNDMA (45/40/15)

| | | | | IRG 651 | HDDA |
|---|---|---|---|---|---|
| Example | Macromonomer | mole % EO | phr | (phr) | (phr) |
| EX3 | M600-ACM | 10 | 20 | 0.2 | 0.1 |
| EX4 | M2005-ACM | 17 | 20 | 0.2 | 0.1 |

The rheological properties of the adhesive compositions are shown in Table 5.

TABLE 5
Rheological properties of the adhesive compositions

| | | Rheology Temperature Ramp | | | |
|---|---|---|---|---|---|
| | | (1 Hz, 3° C./min. <5% ε) | | | |
| | | T_{g} | G′ 25° C. | G′ 85° C. | Tan(δ) |
| Example | Macromer Type | (° C.) | (kPa) | (kPa) | 70° C. |
| EX1 | M600-ACM | −17.4 | 72 | 27 | 0.324 |
| EX2 | M2005-ACM | −21.0 | 66 | 34 | 0.230 |
| EX3 | M600-ACM | −34.6 | 34 | 17 | 0.239 |
| EX4 | M2005-ACM | −35.2 | 39 | 28 | 0.120 |
| CE1 | 550 MPEG-A | −21.2 | 79 | 26 | 0.356 |
| CE2 | 1000 MPEG-A | −24.9 | 52 | 20 | 0.365 |
| CE3 | 500 PPG-A | −15.6 | 80 | 48 | 0.157 |
| CE4 | 500 PPG-A | −17.1 | 89 | 71 | 0.045 |
| CE5 | M1000-ACM | −20.2 | 64 | 24 | 0.380 |

The peel adhesion of the adhesive tapes was measured under controlled temperature and humidity (CTH) conditions (21° C., 50 percent relative humidity (RH)) both initially and after aging for 2 weeks at 65° C. and 95 percent RH. The results are reported in Table 6 for adherence to stainless steel (SS). Most of the tapes decrease in adhesion over time when exposed to elevated temperature and humidity. The comparative examples CE1 and CE2, which contain an acrylate macromer, decrease by more than 90%. However, the PPG-ACM samples (EX1 and EX2) only decrease by 30-40%. CES, which uses M1000-ACM and has a larger amount of PEG relative to PPG than M600-ACM or M2005-ACM, is also seemingly water sensitive and decreases in adhesion and fails inter-facially between the backing and the adhesive (sometimes referred to as #2 bond or #2B).

TABLE 6
180 degree Peel adhesion data of the tapes from stainless steel

| | | | | SS Peel | |
|---|---|---|---|---|---|
| | | | SS Peel | Adhesion - | |
| | | | Adhesion - | 2 weeks | |
| | | mole | 1 day | at 65° C. | |
| | Macromer | % | at CTH | and 95% RH | % |
| Example | Type | EO | (N/mm) | (N/mm) | Change |
| EX1 | M600-ACM | 10 | 0.84 Adh | 0.48 Adh | −43% |
| EX2 | M2005-ACM | 17 | 0.68 Adh | 0.49 Adh | −28% |
| EX3 | M600-ACM | 10 | 0.43 Adh | 0.40 Adh | −7% |
| EX4 | M2005-ACM | 17 | 0.38 Adh | 0.58 Adh | +53% |
| CE1 | 550 MPEG-A | 100 | 0.89 Adh | 0.07 Adh | −92% |
| CE2 | 1000 MPEG-A | 100 | 0.67 Adh | 0.06 Adh | −91% |
| CE3 | 500 PPG-A | 0 | 0.64 Adh | 0.20 Adh | −69% |
| CE4 | 500 PPG-A | 0 | 0.52 Adh | 0.15 Adh | −71% |
| CE5 | M1000-ACM | 86 | 0.63 Adh | 0.14 #2B | −78% |

Table 7 shows adherence to polypropylene (PP) after one day at 21° C. and 50 percent relative humidity.

TABLE 7
180° Peel adhesion data of the tapes from polypropylene

| | | | PP Peel Adhesion - 1 day |
|---|---|---|---|
| Example | Macromer Type | mole % EO | (N/mm) |
| EX1 | M600-ACM | 10 | 0.48 Adh |
| EX2 | M2005-ACM | 17 | 0.34 Adh |
| EX3 | M600-ACM | 10 | 0.17 Adh |
| EX4 | M2005-ACM | 17 | 0.15 Adh |
| CE1 | 550 MPEG-A | 100 | N/A |
| CE2 | 1000 MPEG-A | 100 | 0.41 Adh |
| CE3 | 500 PPG-A | 0 | 0.31 Adh |
| CE5 | M1000-ACM | 86 | 0.52 Adh |

1. (canceled)

2. An adhesive composition comprising a first polymer and a second polymer, wherein
the first polymer is derived from a first polymerizable composition comprising
1) an alkyl (meth)acrylate; and
2) an optional polar monomer; and
the second polymer is derived from a second polymerizable composition comprising
1) a polyether (meth)acrylamide macromer having a polyether group comprising at least 50 mole percent propylene oxide based on total moles of alkylene oxide in the polyether group;
2) an alkyl (meth)acrylate;
3) an optional polar monomer; and
4) a crosslinking agent.

3. The adhesive composition of claim 2, wherein the first polymerizable composition, the second polymerizable composition, or both further comprise the polar monomer.

4. The adhesive composition of claim 2, wherein the adhesive composition comprises
a) 0.5 to 20 weight percent of the first polymer based on a total weight of polymeric material within the adhesive composition, wherein the first polymer has a weight average molecule weight of at least 100,000 Daltons; and
b) 80 to 99.5 weight percent of the second polymer based on the total weight of polymeric material within the adhesive composition, wherein the second polymer is crosslinked.

5. The adhesive composition of claim 1, wherein the first polymerizable composition comprises 50 to 99 weight percent alkyl (meth)acrylate and 1 to 50 weight percent polar monomer based on a total weight of polymerizable components in the first polymerizable composition.

6. The adhesive composition of claim 5, wherein the first polymerizable composition comprises an acidic polar monomer and a non-acidic polar monomer.

7. The adhesive composition of claim 2, wherein the second polymerizable composition comprises 25 to 95 weight percent alkyl (meth)acrylate, 0.5 to 40 weight percent polar monomer, 2 to 50 weight percent polyether (meth)acrylamide macromer, and 0.01 to 5 weight percent crosslinking agent based on a total weight of polymerizable components in the second polymerizable composition.

8. The adhesive composition of claim 2, wherein the polyether (meth)acrylamide macromer has a weight average molecular weight in a range of 300 to 12,000 Daltons.

9. The adhesive composition of claim 2, wherein the adhesive composition comprises 5 to 20 weight percent first polymer and 80 to 95 weight percent second polymer based on a total weight of polymeric material within the adhesive composition.

10. The adhesive composition of claim 2, wherein the adhesive composition is a pressure-sensitive adhesive.

11. An article comprising:
a) a substrate; and
b) an adhesive composition of claim 2 positioned adjacent to the substrate.

12. The article of claim 11, wherein the article is a transfer tape, a one-sided adhesive tape, a dual-sided adhesive tape, or a die-cut adhesive article.

13. The article of claim 11, wherein the article is an electronic device incorporating the adhesive composition.

14. A method of making an adhesive composition, the method comprising:
a) providing a first polymerizable composition comprising:
1) an alkyl (meth)acrylate; and
2) an optional polar monomer;
b) forming a syrup composition by partially polymerizing the first polymerizable composition, wherein the syrup composition comprises
1) 1 to 20 weight percent of solute polymer based on a total weight of the syrup composition, the solute polymer being a first polymer having a weight average molecular weight of at least 100,000 Daltons;
2) 80 to 99 weight percent of solvent monomers based on a total weight of the syrup, the solvent monomers comprising
i) the alkyl (meth)acrylate; and
ii) the optional polar monomer; and
c) preparing a second polymerizable composition comprising
1) the syrup composition;
2) a polar monomer if the syrup composition is free of the optional polar monomer or more polar monomer is desired;
3) a polyether (meth)acrylamide macromer having a polyether group comprising at least 50 mole percent propylene oxide based on total moles of alkylene oxide in the polyether group; and
4) a crosslinking agent;
d) polymerizing the second polymerizable composition to form the adhesive composition comprising
1) the first polymer; and
2) a second polymer,
wherein the second polymer or both the second polymer and the first polymer are crosslinked.

15. (canceled)
